(19) United States
(12) Patent Application Publication
(10) Pub. No.: US 2010/0041281 A1
(43) Pub. Date: Feb. 18, 2010

(54) ELECTRICAL FITTING INCLUDING AN INTERGRAL GROUNDING MECHANISM

(76) Inventor: David Angelo Quattro, Fairfax, CA (US)

Correspondence Address: Richards Patent Law, 3501 N. Southport Ave., Suite 493, Chicago, IL, 60657, US

(21) Appl. No.: 12/541,910

(22) Filed: Aug. 14, 2009

Related U.S. Application Data
(60) Provisional application No. 61/089,499, filed on Aug. 15, 2008.

(51) Int. Cl. H01R 4/30

(52) U.S. Cl. 439/801

(57) ABSTRACT

An electrical fitting includes an electrically conductive body with a mating portion. The body includes an electrically conductive grounding surface integral with the body. A fastener that is movable from a first position to a second position may secure a grounding conductor to the grounding surface to securely electrically couple the grounding conductor to the grounding surface.

### CROSS-REFERENCE TO RELATED APPLICATIONS

This application incorporates by reference and claims priority to U.S. Provisional Patent Application No. 61/089,499 filed Aug. 15, 2008.

### TECHNICAL FIELD

The present subject matter relates generally to an electrical fitting. More specifically, the present invention relates to an electrical fitting including an integral grounding mechanism.

### BACKGROUND OF THE INVENTION

Electrical fittings are used in many areas of technology. For example, electrical fittings may be used to join sections of conduit or join conduit to another electrical enclosure. In many applications, including AC and DC power applications, the conduit itself should be electrically grounded.

For example, an electrical fitting may be used to terminate a run of grounded conduit, in indoor or outdoor applications. Previously, such applications may have required a complicated multi-step installation including using a close nipple, two lock rings and a ground bushing having a grounding lug attached thereto. In such applications, the grounding lug was attached to the ground bushing by a 10-32 screw. The conduit could be grounded by coupling a ground wire to the grounding lug using the ground bushing. During installation the ground lug needed to be removed before the bushing could be tightened. Then the lug was re-installed to accept the ground wire. Because the best electrical connection is often an integral connection, the electrical function of the multi-piece installation may be compromised compared to that of an integral connector.

In the example provided, an installer is burdened by the number of pieces required, which impacts the part count and the overall cost, the time and attention required for installation, as well as the electrical integrity. Accordingly, a need exists for an electrical fitting including an integral grounding mechanism as described and claimed herein.

### BRIEF SUMMARY OF THE INVENTION

An electrical fitting includes: an electrically conductive body including a mating portion; an electrically conductive grounding surface integral with the body; and a fastener movable from a first position to a second position, such that a grounding conductor may be placed between the fastener and the grounding surface when the fastener is in the first position and the grounding conductor may be securely electrically coupled to the grounding surface by the fastener when the fastener is in the second position.

An electrical fitting includes: an electrically conductive body including a threaded mating portion; an electrically conductive channel integrated with the body adapted to receive a ground wire; and a locking piece movable between an unlocked position and a locked position wherein, with a grounding conductor located within the channel and the locking piece in the locked position, the locking piece electrically couples the grounding conductor to the channel and body.

An electrical fitting includes: an electrically conductive body including a threaded profile and an approximately hexagonal shoulder; three wings integrated with and extending from the approximately hexagonal shoulder, wherein each wing includes a channel to receive a ground wire, further wherein each wing includes a threaded bore through which an adjustable screw may extend to electrically couple a grounding conductor placed in one of the channels to an outer surface of the hexagonal shoulder.

In the example provided, an installer is burdened by the number of pieces required, which impacts the part count and the overall cost, the time and attention required for installation, as well as the electrical integrity.

An advantage of the electrical fitting is a reduced part count over known grounded fittings.

Another advantage of the electrical fitting is the inclusion of an integrated grounding surface.

A further advantage of the electrical fitting can be installed without specialized tools.

Yet another advantage of the electrical fitting is that the grounding connection can be made securely mechanically and electrically.

Another advantage of the electrical fitting is that the grounding connection may be made at any one of a plurality of points, thereby increasing the accessibility of the grounding mechanism.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is an isometric view of an example of an electrical fitting including an integral grounding mechanism.

FIG. 2 is an exploded isometric view of an electrical fitting including an integral grounding mechanism coupling an electrical box, an electrical conduit and a ground wire.

FIG. 3 is an isometric view of another example of an electrical fitting including an integral grounding mechanism.

FIG. 4 is an isometric view of another example of an electrical fitting including an integral grounding mechanism.

FIG. 5 is an isometric view of another example of an electrical fitting including an integral grounding mechanism.

### DETAILED DESCRIPTION OF THE INVENTION

An electrical fitting includes: an electrically conductive body including a mating portion; an electrically conductive grounding surface integral with the body; and a fastener movable from a first position to a second position, such that a grounding conductor may be placed between the fastener and the grounding surface when the fastener is in the first position and the grounding conductor may be securely electrically coupled to the grounding surface by the fastener when the fastener is in the second position.

An electrical fitting includes: an electrically conductive body including a threaded mating portion; an electrically conductive channel integrated with the body adapted to receive a ground wire; and a locking piece movable between an unlocked position and a locked position wherein, with a grounding conductor located within the channel and the locking piece in the locked position, the locking piece electrically couples the grounding conductor to the channel and body.

An electrical fitting includes: an electrically conductive body including a threaded profile and an approximately hexagonal shoulder; three wings integrated with and extending from the approximately hexagonal shoulder, wherein each wing includes a channel to receive a ground wire, further wherein each wing includes a threaded bore through which an adjustable screw may extend to electrically couple a grounding conductor placed in one of the channels to an outer surface of the hexagonal shoulder.

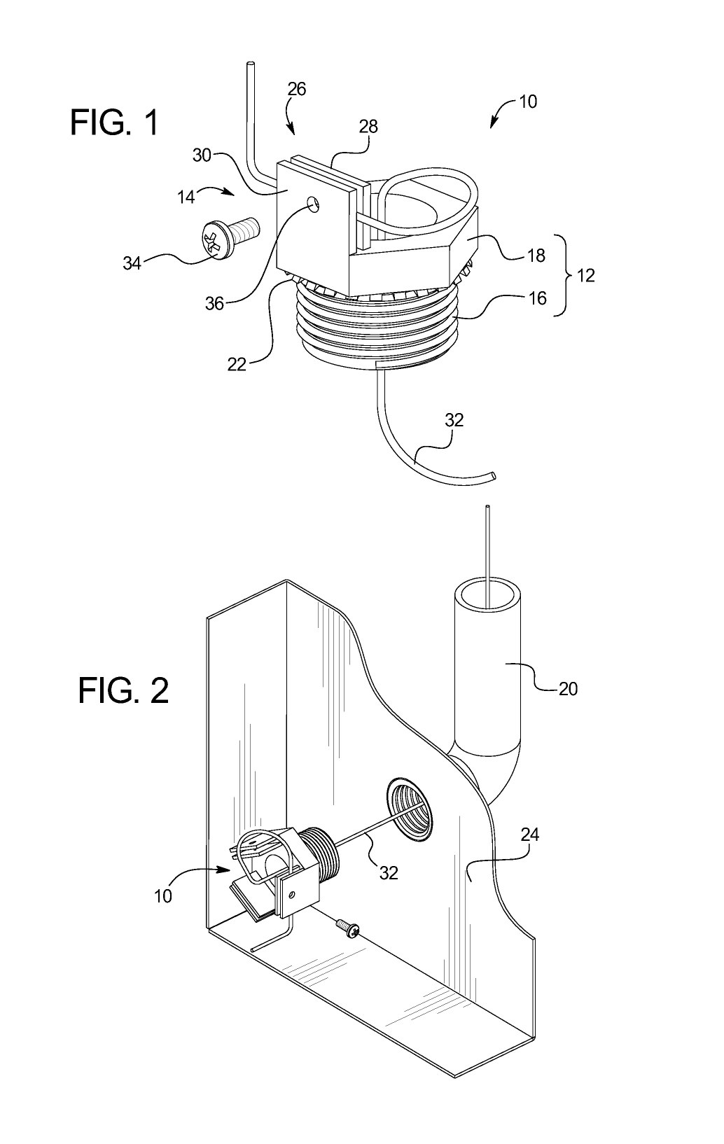

FIG. 1 illustrates an example of an electrical fitting 10. The embodiment of the electrical fitting 10 shown in FIG. 1 includes a body 12 and an integral grounding mechanism 14. The body 12 and integral grounding mechanism 14 shown in FIG. 1 are formed from die cast zinc. However, it is contemplated that the electrical fitting 10 may be formed from any conductive material or materials. For embodiments of the electrical fitting 10 intended for out door use or otherwise exposed to inclement weather, the electrical fitting may be formed from non-corrosive materials. For example, the electrical fitting 10 may be formed from aluminum and then coated with tin or nickel. These materials may help prevent galvanic corrosion, which is a problem when dissimilar metals contact one another.

As shown in FIG. 1, the body 12 includes a mating portion 16 and a shoulder 18. The mating portion 16 shown in FIG. 1 is an externally threaded shaft 16 for mating with an internally threaded part, such as, for example, an electrical conduit 20 (shown in FIG. 2). However, it is contemplated that the electrical fitting 10 may include any type of mating portion 16 adapted for connecting to various items, for example, by including an internally threaded shaft 16 (shown in FIG. 4), using compression fittings (not shown), the push fit couplers and adapters sold under the trademark Sharkbite (not shown), etc. Accordingly, the electrical fitting 10 may be adapted to mate with any number of corresponding parts. For example, the electrical fitting 10 can be used in conjunction with a ‘combination coupling’ which receives EMT (electric metallic tubing) on one side and is threaded female on the other side.

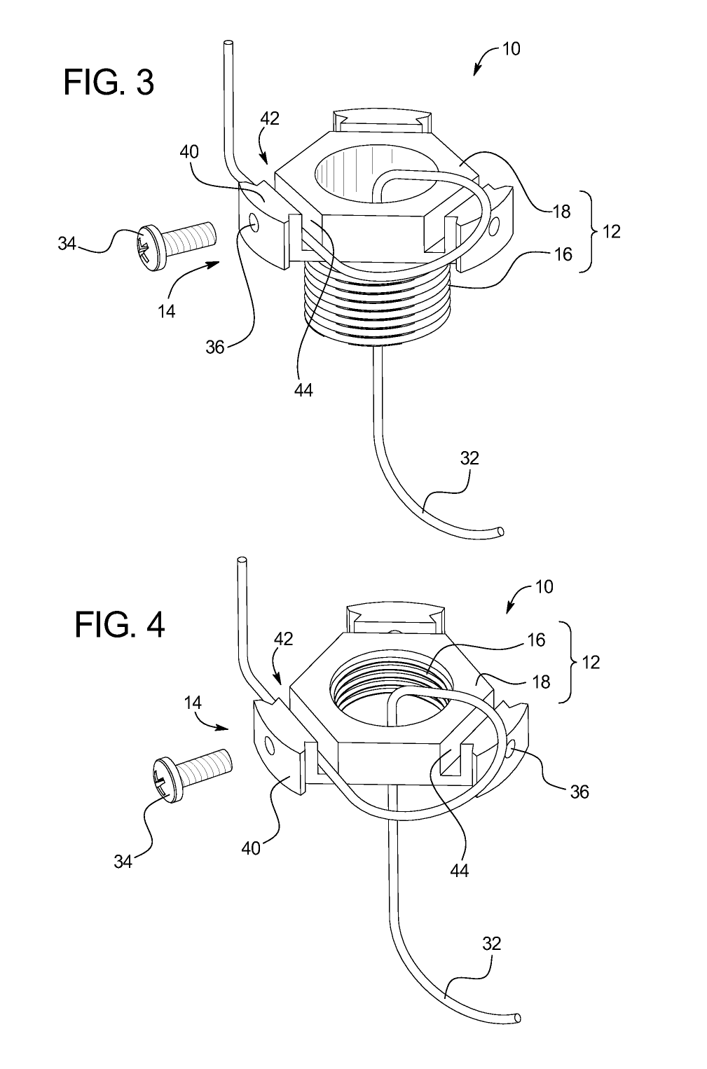

As further shown in FIG. 1, the embodiment of the electrical fitting 10 depicted includes a shoulder 18 at one end of the shaft 16, upon which the grounding mechanism 14 is formed. In the example shown in FIG. 1, the shoulder 18 is an approximately hexagonal bolt head that enables an installer to install the electrical fitting 10 using common tools. The shoulder 18 shown in FIG. 1 is approximately hexagonal as the six faces of the shoulder 18 are not identical in length. However, it is contemplated that the installation of the electrical fitting 10 may be accomplished without a need for a shoulder 18, may be accomplished via an alternatively configured shoulder 18 or may not require any specific structure for installation at all. For example, the embodiments shown in FIGS. 3-5 and described further herein illustrate variations on the shoulder 18 structure.

The shoulder 18 shown in FIG. 1 includes a toothed profile 22 facing the threaded shaft 16 of the body 12. The toothed profile 22 is provided to secure the connection between the electrical fitting 10 and any item to which it is affixed. For example, when securing the electrical fitting 10 to an electrical box 24 (shown in FIG. 2), the toothed profile 22 may cut into the surface of the electrical box 24 to engage the metal wall of the electrical box 24. In some cases, the toothed profile 22 may improve both the physical connection and the electrical connection between the electrical fitting 10 and the item to which it is attached. In the example shown in FIG. 1, the toothed profile 22 is formed integrally with the shoulder 18. The teeth are about 1/16 long and are angled such that as the electrical fitting 10 is tightened, the teeth cut into the paint on the enclosure (e.g., the electrical box 24) and prevent the electrical fitting 10 from loosening in the counter-clockwise direction. However, it is understood that the toothed profile 22 shown in FIG. 1 is merely one example of a toothed profile 22 that may be adapted for use with the electrical fitting 10. Additionally, the electrical fitting 10 may perform its function without the need for any toothed profile 22.

In the example of the electrical fitting 10 shown in FIG. 1, the integral grounding mechanism 14 includes a pair of tabs 26 integrated with and extending from the shoulder 18. As shown, the pair of tabs 26 includes an interior tab 28 and an exterior tab 30 with a space between them to receive a ground wire 32 or other grounding conductor. As further shown, the exterior tab 30 of each pair of tabs 26 includes an adjustable screw 34 adapted to thread through a threaded hole 36 in the exterior tab 30 to electrically couple the ground wire 32 to the interior tab 28. In this example, the interior tab 28 of the pair of tabs 26 functions as a grounding surface against which the ground wire 32 may be affixed. Further, the space partially enclosed by the pair of tabs 26 and the shoulder 18 functions as a channel into which the ground wire 32 may be placed. This arrangement provides a convenient channel for placing the ground wire 32 such that it may be mechanically affixed to the grounding surface provided by the interior tab 28 to provide electrical continuity between the grounding conductor and the electrical fitting 10.

In the example of an electrical fitting 10 shown in FIG. 2, there are multiple sets of pairs of tabs 26. As shown in FIG. 2, the three sets of pairs of tabs 26 are equally spaced apart from each other on the shoulder 18. By providing three equally spaced pairs of tabs 26, an installer will have the choice of using the most convenient pair of tabs 26 for installation. This provides greater flexibility for installations that may be difficult to access. However, it is understood that a grounding mechanism 14 including a single pair of tabs 26 (as shown in FIG. 1), a single channel or a single grounding surface may be desired in some instances, as may other various numbers of pairs of tabs 26, channels or surfaces. For example, if the shoulder 16 were to be approximately in the form of an octagonal bolt head, it may be beneficial to incorporate four pairs of tabs 26.

The adjustable screw 34 shown in FIG. 1 is a terminal screw that mechanically secures the ground wire 32 to the interior tab 28 to create an electrical connection between the ground wire 32 and the grounding mechanism 14. In the example shown in FIG. 1, the adjustable screw 34 is a stainless steel screw of size-pitch 10-32. It is understood that the adjustable screw 34 illustrated in FIG. 1 is merely one example of a fastener functioning as a locking mechanism that may be used in the electrical fitting 10. In addition, the locking mechanism may be formed, for example, by physically deforming a portion of the electrical fitting 10. In one example, the locking mechanism may be an irreversible crimp, where a portion of the electrical fitting 10 is permanently deformed to capture the ground wire 32 in its grasp.

Referring now to FIG. 2, an electrical fitting 10 is shown connecting conduit 20 to an electrical box 24. As shown in FIG. 2, a ground wire 32 running through the conduit 20 may pass through the wall of the electrical box 24 where it attaches to the grounding mechanism 14 of the electrical fitting 10 and then passes to a grounded point. For example, the box may include a grounding bus that is electrically grounded, for example by being connected to a grounding bar that is physically inserted in the earth, and the ground wire 32 may connect the grounding buss to the electrical fitting 10. As such, the ground wire 32 grounds the electrical fitting 10, the electrical box 24 and the conduit 20. Additionally, the end of the ground wire 32 that passes through the conduit may then be used to ground a device on the other end of the conduit, for example, an electrical outlet or electronic device.

FIG. 3 illustrates another example of the electrical fitting 10. As shown in FIG. 3, the integral grounding mechanism 14 may be formed using different structure than the pairs of tabs 26 described above with respect to FIG. 1. For example, as shown in FIG. 3, the grounding mechanism 14 may include a wing 40 protruding from the shoulder 18, wherein the wing 40 includes a channel 42. The wing 40 and channel 42 function similarly to the pair of tabs 26 shown in FIG. 1 in that the wing 40 and channel 42 receive a ground conductor, for example a ground wire 32, and use a fastener, for example a screw 34, to secure the ground conductor to a grounding surface 44, for example, as shown in FIG. 3, the outer wall of the shoulder 18.

As shown in FIG. 3, an approximately hexagonal bolt head may be employed. As with the example shown in FIG. 1, the shoulder 18 shown in FIG. 3 is not a proper hexagon, rather one set of three alternating sides are shorter than the other three. This embodiment of the electrical fitting 10 can be installed without the use of a wrench or special tool simply by holding a tool, such as a flat blade screwdriver, in one of the channels 42 in the wings 40 and the shoulder 18 and torquing the electrical fitting 10 into place.

FIG. 4 illustrates an embodiment of the electrical fitting 10 shown in FIG. 3, only incorporating a female mating portion, shown as an internally threaded shaft 16, rather than the externally threaded shaft 16 shown in FIG. 3.

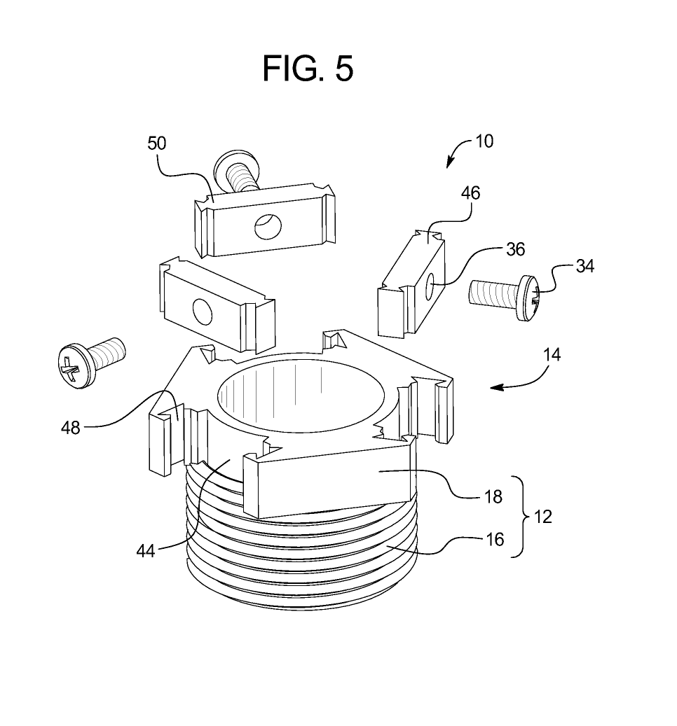

Referring now to FIG. 5, another example of the electrical fitting 10 is shown. The electrical fitting 10 shown in FIG. 5 includes many of the same features of the embodiments shown in FIGS. 1-4, but utilizes a different integral grounding mechanism 14. The integral grounding mechanism 14 shown in FIG. 5 includes a removable panel 46 including a threaded hole 36 for receiving a threaded screw 34. The removable panel 46 slides into and out of a receiving slot 48 to provide unrestricted access to the grounding surface 44. As shown in FIG. 5, the removable panel 46 includes a male mating portion 50 adapted to slide into the receiving slot 48. In use, the removable panel 46 may be removed from the electrical fitting 10, the grounding wire 32 may be placed against the grounding surface 44, the removable panel 46 may be replaced and the screw 34 may be inserted through the threaded hole 36 to secure the ground wire 32 against the grounding surface 44. The force of the screw 34 against the body 12 helps secure or lock the removable panel 46 in place.

It should be noted that the example shown in FIG. 5 demonstrates an integral grounding mechanism 14 wherein the grounding surface is the integral with the body 12 while other elements of the grounding mechanism 14 (e.g., the screw 34 and removable panel 46) are not integrated with the body 12.

It is understood that the electrical fitting 10 is geometrically scalable to be adapted to various sizes for various applications. It is further understood that the proportions of the electrical fitting 10 may be varied to accommodate different applications. For example, the body 12 may be externally threaded to match the typical threads per inch of the various equipment to which it may attach and may come in various nominal sizes, such as, ½″, ¾″ 1″, 1¼″, 1½″, 2″, etc. It may further be provided in metric sizes. Also, additional features may be included, such as, for example, an elastomeric seal may be included to provide an air-tight or moisture-resistant seal. Other adaptations will be apparent to those having ordinary skill in the art. Additionally, although the body 12 is shown in FIG. 1-5 as including an elongated threaded shaft 16 as the mating portion 16, it is understood that the shape of the mating portion 16 may vary depending on the equipment to which it attaches.

It should be noted that various changes and modifications to the presently preferred embodiments described herein will be apparent to those skilled in the art. Such changes and modifications may be made without departing from the spirit and scope of the present invention and without diminishing its attendant advantages.

I claim:

1. An electrical fitting comprising:
an electrically conductive body including a mating portion;
an electrically conductive grounding surface integral with the body; and
a fastener movable from a first position to a second position, such that a grounding conductor may be placed between the fastener and the grounding surface when the fastener is in the first position and the grounding conductor may be securely electrically coupled to the grounding surface by the fastener when the fastener is in the second position.

2. The electrical fitting of claim 1 wherein the fastener is a threaded screw.

3. The electrical fitting of claim 2 wherein the threaded screw is threaded through a surface opposing the conductive grounding surface, the opposing surface being integral with the body.

4. The electrical fitting of claim 2 wherein the grounding surface is radiused and the threaded bolt is threaded through the grounding surface.

5. The electrical fitting of claim 1 wherein the mating portion includes external threads.

6. The electrical fitting of claim 1 wherein the mating portion includes internal threads.

7. The electrical fitting of claim 1 wherein the mating portion includes a sealing portion.

8. The electrical fitting of claim 1 where in the body includes a hexagonal bolt head.

9. The electrical fitting of claim 1 wherein the body includes a shoulder including a toothed profile.

10. The electrical fitting of claim 1 further including a second electrically conductive grounding surface integral with the body and a second fastener movable from a first position to a second position, such that a grounding conductor may be placed between the second fastener and the second grounding surface when the second fastener is in the first position and the grounding conductor may be securely electrically coupled to the second grounding surface by the second fastener when the second fastener is in the second position.

11. An electrical fitting comprising:
an electrically conductive body including a threaded mating portion;
an electrically conductive channel integrated with the body adapted to receive a ground wire; and
a locking piece movable between an unlocked position and a locked position wherein, with a grounding conductor located within the channel and the locking piece in the locked position, the locking piece electrically couples the grounding conductor to the channel and body.

12. The electrical fitting of claim 11 wherein the integrated channel is formed between two tabs integrated with and extending from the body.

13. The electrical fitting of claim 11 wherein the body includes a hexagonal shoulder continuous with the integrated channel.

14. The electrical fitting of claim 11 further including a second conductive channel integrated with the body adapted to receive a grounding conductor.

15. The electrical fitting of claim 11 wherein the locking piece is a terminal screw.

16. An electrical fitting comprising:
an electrically conductive body including a threaded profile and an approximately hexagonal shoulder;
three wings integrated with and extending from the approximately hexagonal shoulder, wherein each wing includes a channel to receive a ground wire, further wherein each wing includes a threaded bore through which an adjustable screw may extend to electrically couple a grounding conductor placed in one of the channels to an outer surface of the hexagonal shoulder.

17. The electrical fitting of claim 16 wherein the three wings are approximately equally spaced from each other.

18. The electrical fitting of claim 16 wherein the body includes an externally threaded profile.

19. The electrical fitting of claim 16 wherein the approximately hexagonal shoulder includes a toothed profile.

20. The electrical fitting of claim 16 wherein the body further includes an elastomeric seal.
